(19) United States
(12) Patent Application Publication
(10) Pub. No.: US 2014/0076010 A1
(43) Pub. Date: Mar. 20, 2014

(54) MULTI-ACCESS LOCK

(71) Applicant: SCOTT GOLD, Marina Del Ray, CA (US)

(72) Inventor: SCOTT GOLD, Marina Del Ray, CA (US)

(21) Appl. No.: 13/619,517

(22) Filed: Sep. 14, 2012

(51) Int. Cl. E05B 67/06; E05B 37/02; E05B 67/18

(52) U.S. Cl. 70/21; 70/20; 70/31; 70/22; 70/53

(57) ABSTRACT

A locking device useful for example for bicycles in which a pair of shackles is spaced apart and fittable into cross bars, each cross bar having a locking mechanism so that the locking device can be locked and opened at either end, that is, at either cross bar.

### BACKGROUND

1. Field of the Invention

The invention relate to locks, in particular to locks for bicycles, motor scooters and motorcycles.

2. General Background and State of the Art

A type of lock device which is popular for bicycles, motor scooters and motorcycles is a lock series made by Kryptonite Corp of Canton, Mass. These locks are typified by a U shaped shackle attached at its ends to a cross bar which has a lock mechanism to hold and release the shackle. These are commonly referred to as a U-lock. In these locks, the keyway can be placed at the end of the cross bar or midway of the cross bar between the ends of the shackle. See U.S. Pat. No. 5,406,812 (lock at end of cross bar) and U.S. Pat. No. 5,010,746 (lock between ends of shackle). FIG. 1 is exemplary. In use the lock is placed around a part of a bicycle frame or wheel and a public bicycle parking stall or rack. When this is done, it is often the case that the lock is facing downwardly and is low to the ground. Bicycles can be locked to bike racks, poles, benches, in fact any structure that will give the desired security. Sometimes the type of structure and the congestion of many bicycles makes it awkward if not difficult to reach the lock and insert and turn the key to release the lock. In some cases the lock is designed as a combination lock with rotating disks which exacerbates the problem because each disk has to be seen to be rotated to the correct position.

A lock of this type which does not have the disadvantage of difficult access to the lock keyway or combination dials would be advantageous especially during circumstances where the bike rack is full and difficult to maneuver.

### BRIEF DESCRIPTION OF THE DRAWINGS

FIG. 1 is an example of a lock of the prior art.

FIGS. 2A and 2B are an embodiment of the invention having a key lock on each of two cross bars with separate shackles.

FIG. 2C is the embodiment of FIGS. 2A and 2B as disassembled.

FIG. 3 is an embodiment of the invention having a combination lock on each cross bar.

FIG. 4 is an embodiment of the invention having a key lock on one cross bar and a combination lock on the other cross bar.

FIG. 5 is an embodiment of the invention having curved cross bars.

FIG. 6 shows exemplary cross-sectional shaped for the cross bars.

FIG. 7 shows the parts of an embodiment of the invention contained in a container.

FIG. 8 shows an embodiment of the invention in which the shackles are bowed.

FIG. 9 shows an embodiment of the invention in which the shackles are made of semi-rigid hand-bendable steel cable.

FIG. 10 shows an embodiment of the invention in which one shackle is made of semi-rigid hand-bendable steel cable and the other shackle is made of rigid steel.

FIG. 11 shows a portion of a bicycle as an exemplary locking subject in which a part of the bicycle is used in combination with a bicycle rack as a fixed structure and the locking device captures both of them in a way that has one end of the locking device upwardly relative to the other end.

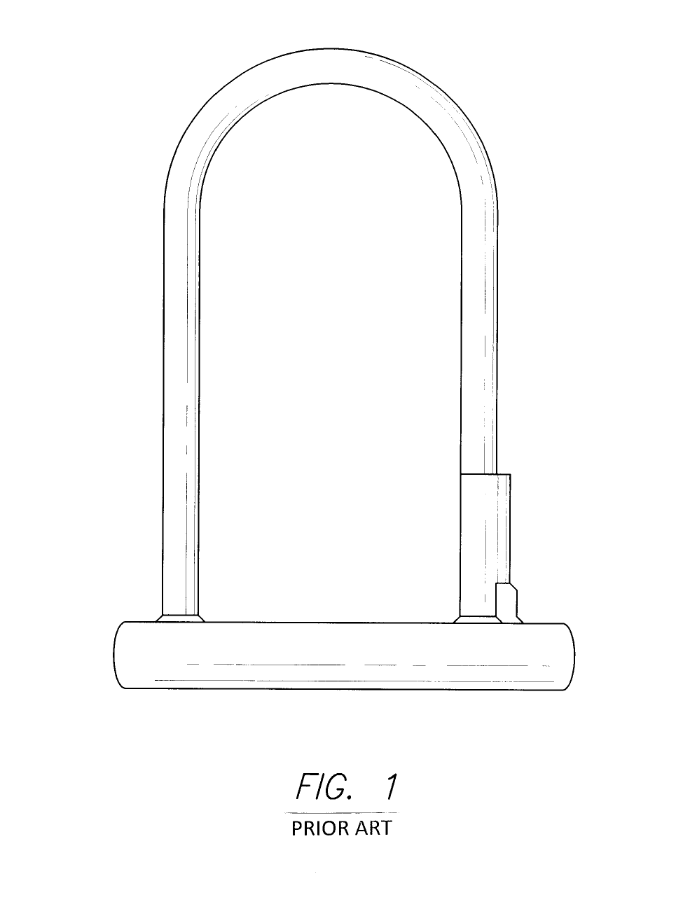

### DETAILED DESCRIPTION

The present invention is based on the realization that the problem of difficult access to the locking mechanism can be solved by having two cross bars each having a locking mechanism so that, while one cross bar may be inaccessible or difficult to access, the other will be more easily accessed and the user then can select the one more conveniently situated. One common circumstance, for example, is that the lock is placed downward facing which along with congestion makes its removal even more problematic.

Another advantage of the present invention, in one embodiment is that the parts of the lock can be dismantled and stored more securely and conveniently than the prior locks of this type. Current U shaped locks when disassembled break into two pieces; however the present invention will allow the lock to be disassembled into four small parts which will ease carrying or transport.

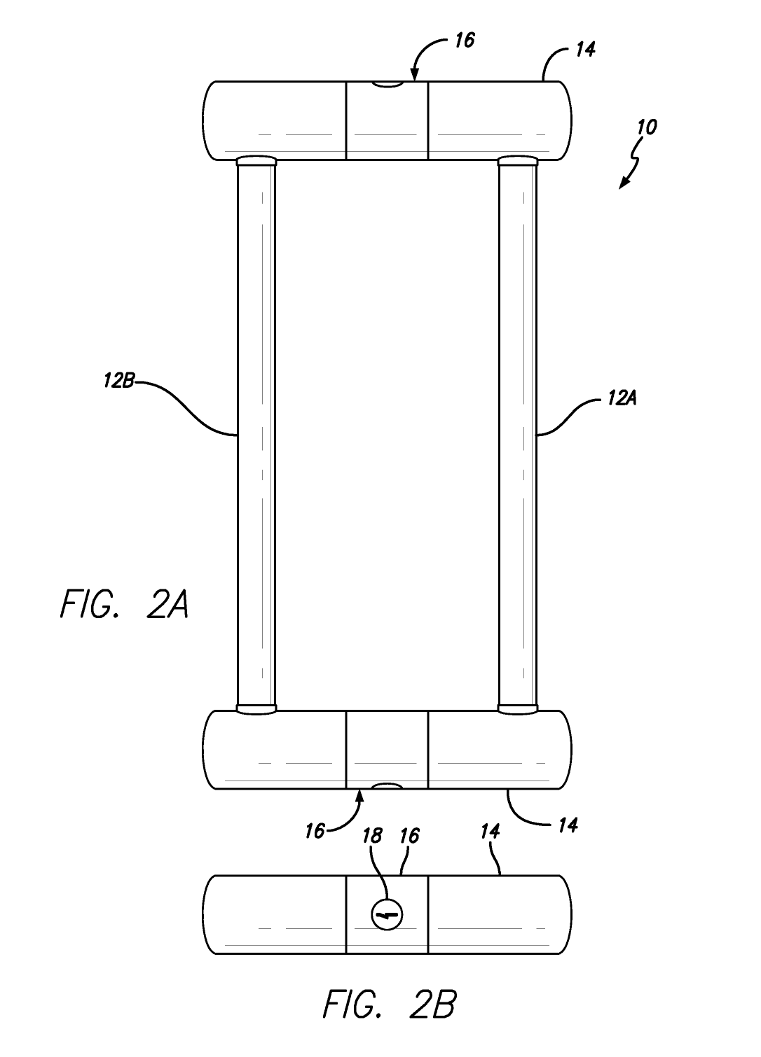

FIGS. 2A and 2B are illustrative of an embodiment of the invention. The locking device 10 has a pair of shackles 12a and 12b mounted at respective ends to identical cross bars 14. Each cross bar 14 has a lock mechanism 16 in it that operates to engage and release the shackles 12a and/or 12b at the respective cross bar. In this illustration, the lock mechanism 16 on each cross bar 14 is a key lock with the keyway 18. The mechanism can be made so that either only one shackle is released or both shackles are released when the lock mechanism is operated. Releasing only one shackle is convenient so long as the unreleased shackle can pivot. But for the most convenience, both shackles should release so that the parts can be recovered from a congested and inconvenient location. FIG. 2C shows the embodiment of FIGS. 2A and 2B as disassembled in which the ends 19 of each shackle are shown as well as keys 17. Equivalent disassembly can be understood for each of the following embodiments.

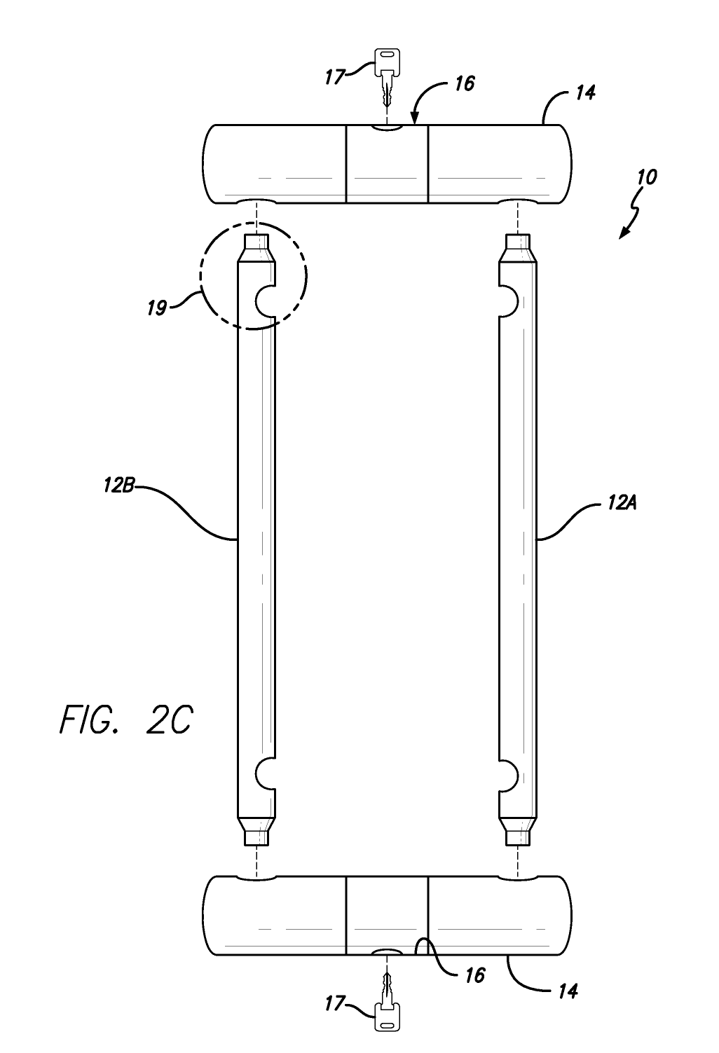

FIG. 3 shows a similar lock 20 but in which the locking mechanism 22 is a combination lock on each cross bar 24 with the combination dials between the shackles 12a and 12b.

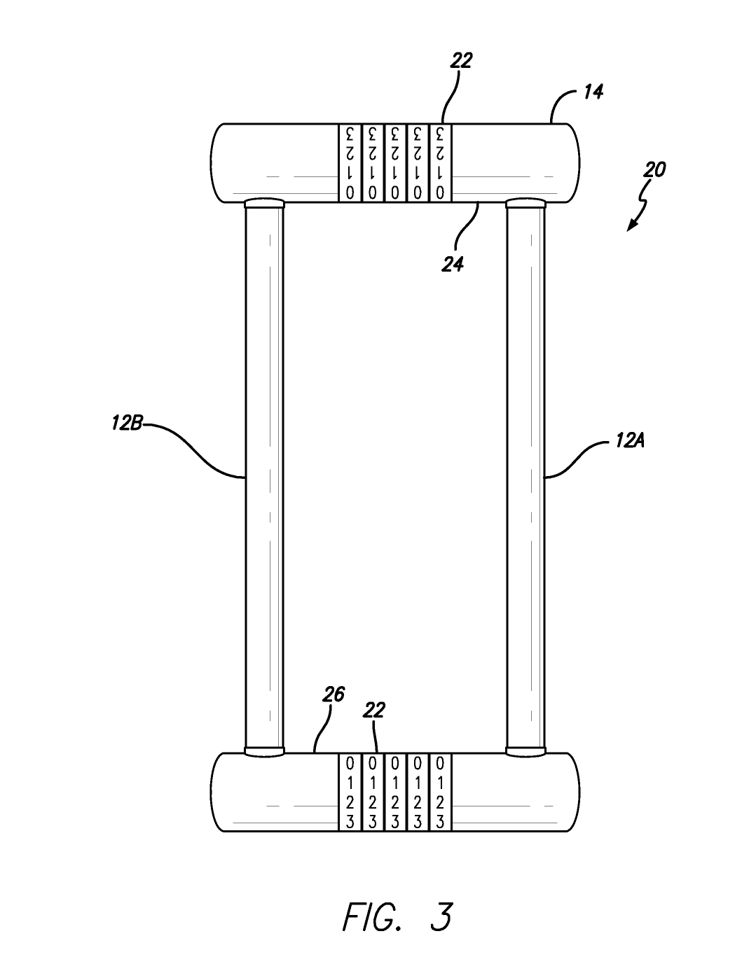

FIG. 4 shows a similar lock 30 in which one cross bar 32 has a combination lock 34 and the other cross bar 36 has a key lock 38.

In these exemplary embodiments, the keyway or combination dials is between the shackles. However, both the placement of the keyway and combination discs can be at the end of the cross bar. Also, the particular mechanism of the lock and how it engages and releases the shackles can be selected from numerous examples or created anew; although it is preferable that both shackles at the cross bar whose lock is operated are released so as to allow the lock to be put in place and removed; however as mentioned above, a design that only releases one shackle is possible. Examples of lock placements can be seen in U.S. Pat. Nos. 4,155,231; 5,010,746; 5,406,812 and 5,647,520 the content of each of which is incorporated herein by reference.

In particular, in U.S. Pat. No. 5,406,812 a mechanism is shown that locks and releases both ends of the U-shaped shackle from the single cross bar (lock case 2) as applied to the present invention, each of the two shackles would be locked and releasable at both ends.

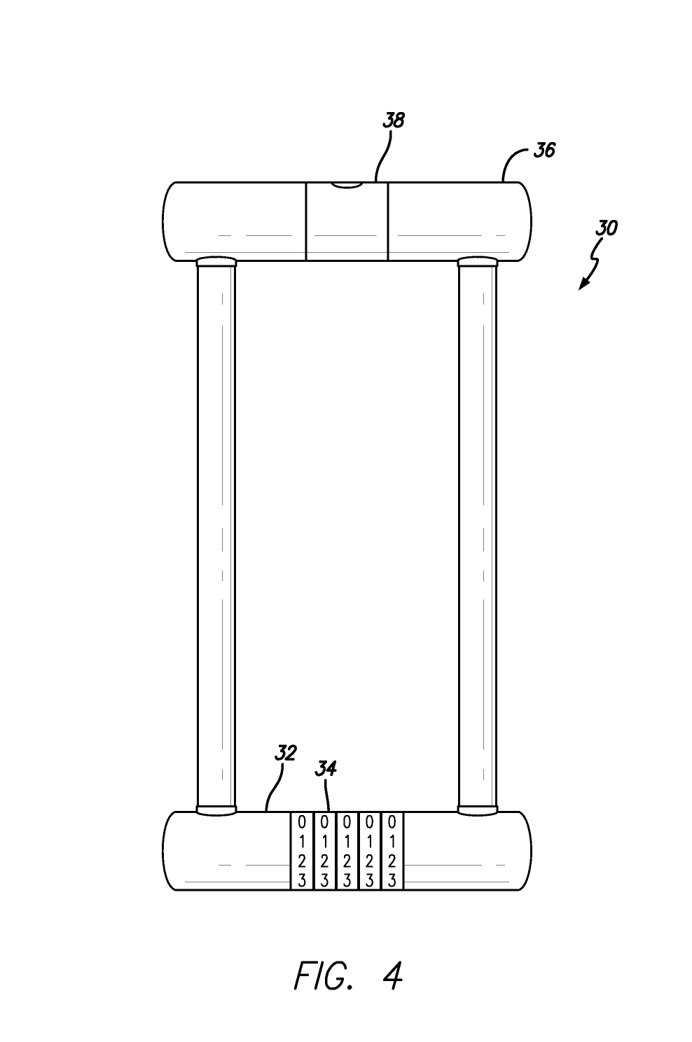

Another embodiment is shown in FIG. 5 in which the lock 40 has the cross bars 42 which are curved and showing combination locks on each. As described above, the curved cross bar embodiment can have any selection of two combination locks, two key locks or one of each.

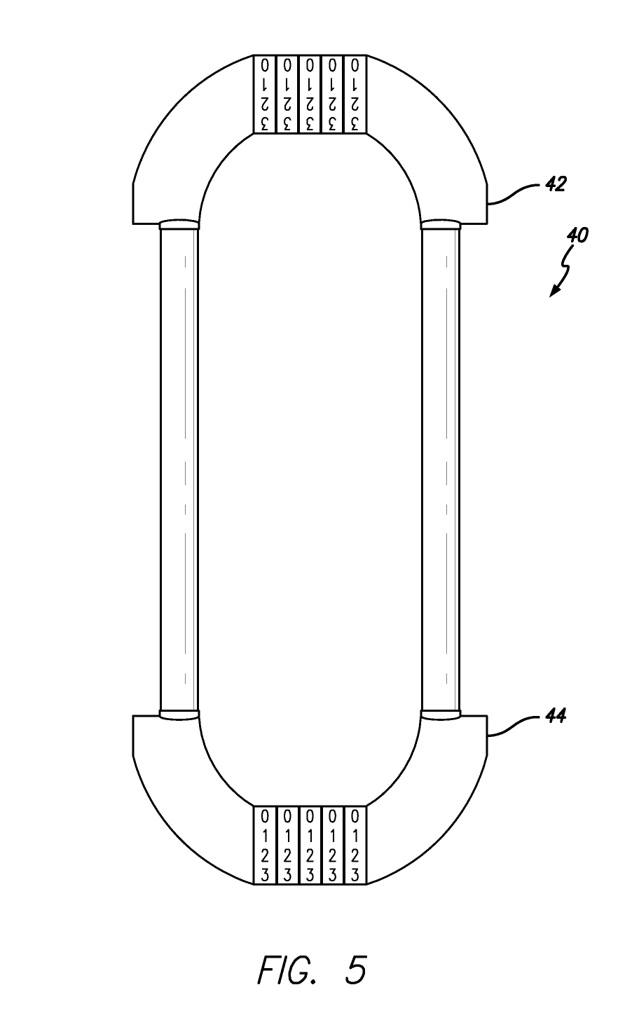

In further embodiments, the cross bars can have any conveniently selected cross-sectional shape such as a round, square (rectangular) or hexagonal cross-sectional shape as shown in FIG. 6.

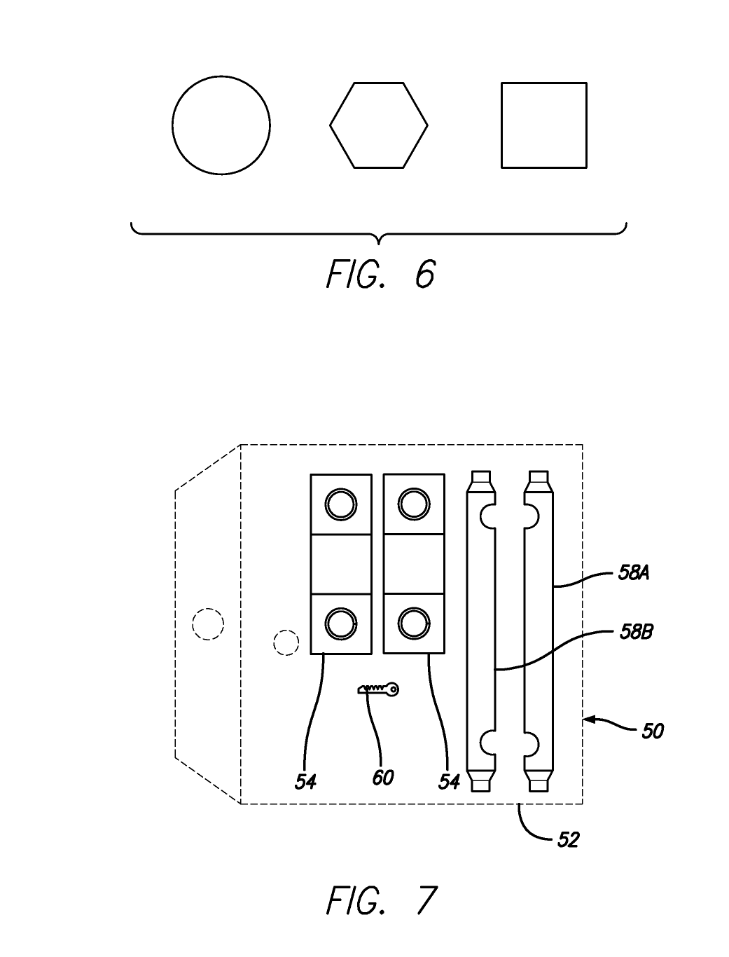

FIG. 7 represents an exemplary packaging 50 for the present invention having a container 52 such a flexible plastic or cloth and the cross bars 54 and the shackles 58a and 58b along with a key 60.

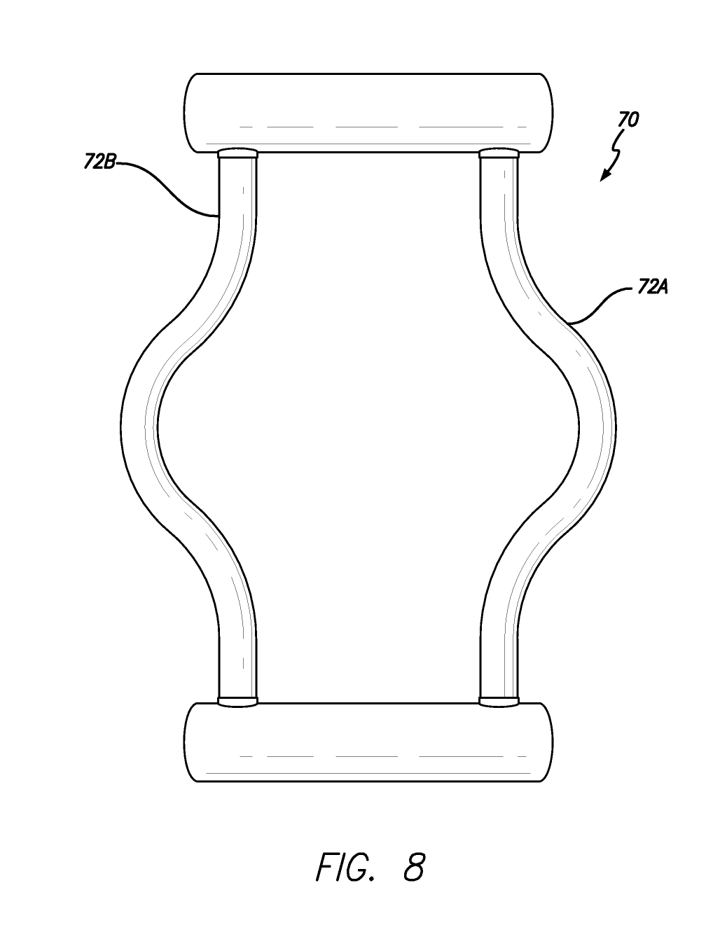

While the shackles have been shown as straight, they could have any selected shape. FIG. 8 is illustrative in which the lock 70 has shackles 72a and 72b which are outwardly bowed.

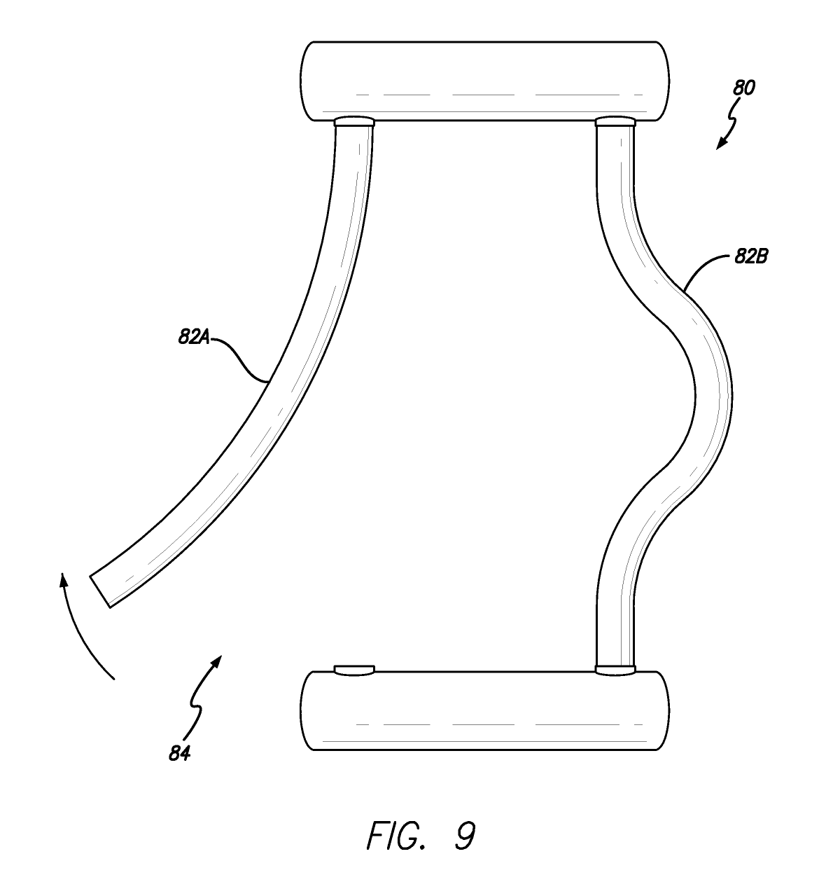

Also, the shackles could be made of a stiff cable which while rigid could be bent by hand to enable it to be fitted to an awkwardly arranged bicycle and locking safety place. In such case, it would be only necessary that a cross bar release one of the shackles because it could be bent away so as to allow the lock to be applied and removed. This is shown in FIG. 9 in which lock 80 has shackles 82a and 82b made of semi-rigid cable, so that as seen for cable 82a, it can be bent away to provide a convenient opening as at 84.

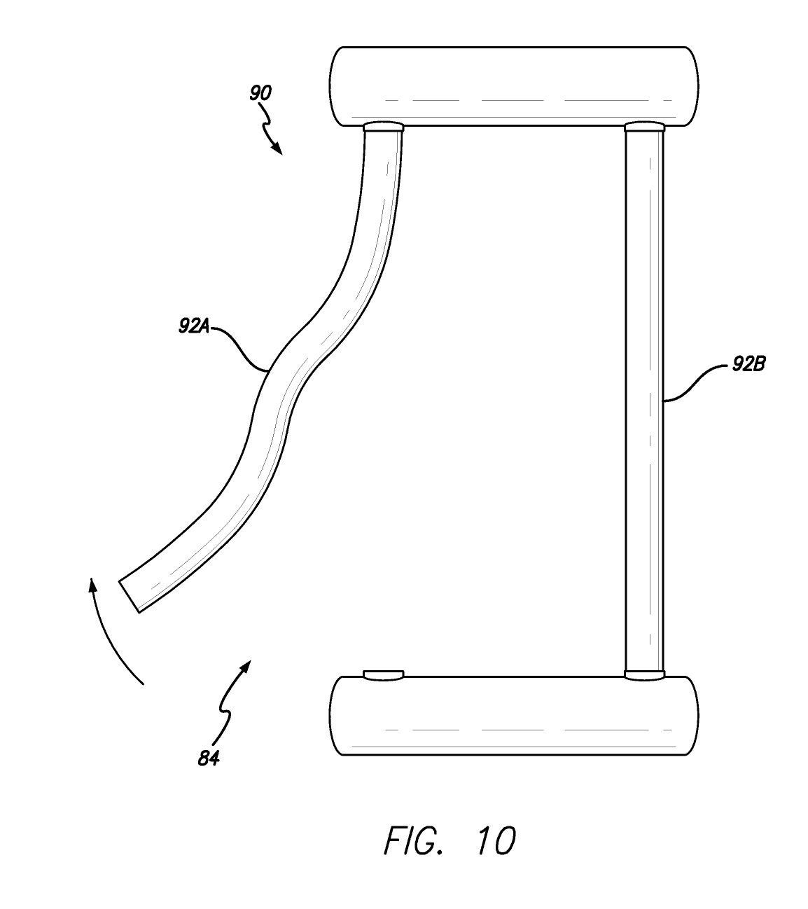

In that regard, as seen in FIG. 10, it is possible to make lock 90 with one shackle 92a of semi-rigid cable and the other 92b of rigid steel.

In use the lock will be applied to a bicycle or other personal vehicle such as a motor scooter or a motorcycle generally referred to as a locking subject and some fixed structure, which will often, but not always be a bicycle rack. Other structures could of course, be utility poles, benches and fences.

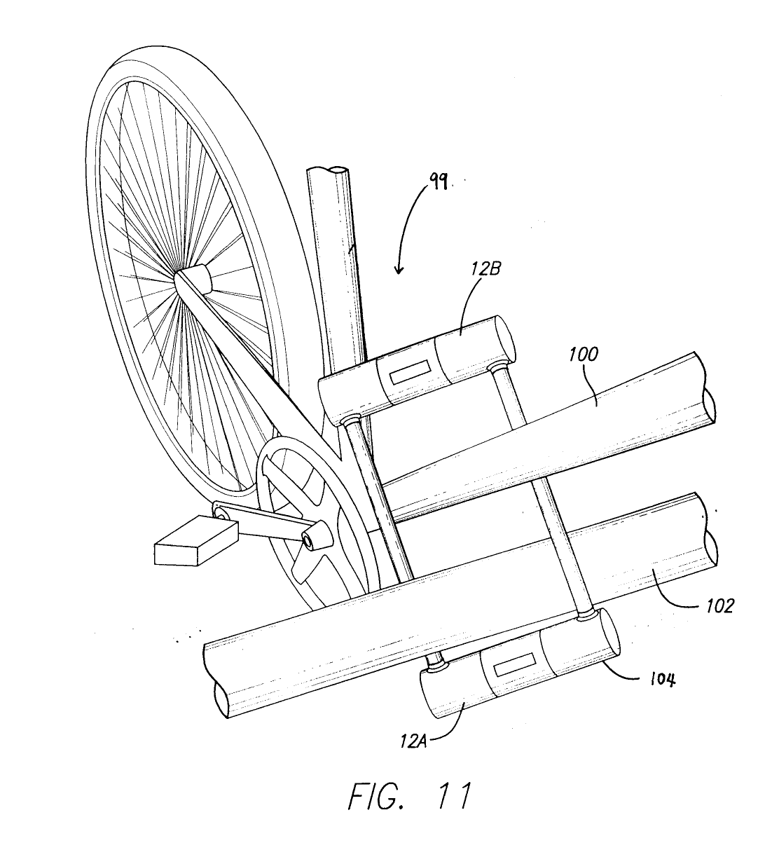

FIG. 11 shows a portion of a bicycle 99, having as a typical part thereof bicycle frame member 100 and a fixed structure exemplary of which is a bicycle rack 102 on which the locking device 104 has been installed. The locking device 104 is at an angle which is typical of these types of bicycle parking arrangements. As can be seen, the cross bar 12a is downwardly facing while the cross bar 12b is upwardly facing. Therefore, the lock can be operated from the upwardly facing cross bar 12b.

While the invention is described in terms of specific embodiments, other embodiments could readily be adapted by one skilled in the art. Accordingly, the scope of the invention is limited only by the following claims.

The foregoing Detailed Description of exemplary embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component or step is explicitly recited in the claims.

1. A method for locking and unlocking a bicycle or motor scooter or motorcycle defining a locking subject to a selected fixed structure comprising:
providing a locking device comprising:
a pair of elongated one piece self supporting shackles each having two ends;
a first cross bar and a second cross bar, each cross bar having a pair of spaced apart receptacles for receiving and locking therein one end of each shackle, the receptacles being proximate ends of the cross bars whereby when the shackles are installed in the receptacles they terminate inside the respective cross bar and the shackles will be in a spaced apart relationship and each of the cross bars having a locking mechanism co-operative with the ends of the shackles when in the receptacles to allow the ends of the shackles to be locked and to be released from locking upon operation of the locking mechanism of the cross bar;
having one of the cross bars removed so as to allow the locking device to be placed to capture a part of the locking subject and the selected fixed structure;
placing the locking device to capture the locking subject and the selected fixed structure; and
locking the locking device;
whereby the locking subject is locked to the fixed structure and can be removed by access to either of the cross bar locking mechanisms.

2. The method of claim 1 further comprising:
unlocking the locking device at a selected one of the cross bars and removing the locking device from the locking subject and the selected fixed structure.

3. The method of claim 1 wherein the locking device is placed so that one cross bar is facing generally upwardly relative to the other cross bar whereby convenient access is available to the locking mechanism of the cross bar that is facing generally upwardly.

4. The method of claim 1 wherein the locking mechanism of each cross bar will lock and release both of the shackles attached to that cross bar.

5. The method of claim 1 wherein the locking mechanism of each cross bar will optionally release only one of the two shackles at that cross bar and the cross bar will be rotatable around the shackle that is not released or it will release both of the two shackles at that cross bar.

6. The method of claim 1 wherein the locking mechanism at the two cross bars is selected from the group consisting of:
a. both locking mechanisms are of the key lock type;
b. both locking mechanisms are of the combination type; and
c. one cross bar has a key type lock and the other has a combination lock.

7. The method of claim 1 wherein the shackles are selected from the group consisting of:
a. both shackles are rigid steel;
b. both shackles are semi-rigid hand-bendable steel cable;
c. one shackle is rigid steel and the other is semi-rigid hand-bendable steel cable.

8. A locking device for locking objects such as bicycles, motor scooters or motorcycles comprising:
a pair of elongated one piece self supporting shackles each having two ends;
a first and second cross bar, each cross bar having a locking mechanism and a pair of spaced apart receptacles for one end of each shackle such that the ends of each shackle terminate inside the respective cross bar and the shackles will be spaced apart when their ends are placed in the receptacles and the locking mechanism of each cross bar being adapted to lock and release at least one of the shackles and wherein assembly of the shackles and the cross bars will determine an open and fixed distance between the shackles and between the cross bars.

9. (canceled)

10. The locking device of claim 8 wherein the locking mechanism of the two cross bars is selected from the group consisting of:
a. both are key operated locking mechanisms;
b. both are combination locking mechanisms; and
c. one is a key operated locking mechanism and the other is a combination locking mechanism.

11. The locking device of claim 9 wherein the shackles are selected from the group consisting of:
a. both shackles are rigid steel;
b. both shackles are semi-rigid hand-bendable steel cable
c. one shackle is rigid steel and the other is semi-rigid hand-bendable steel cable.

12. A securing assembly with a bicycle and a locking device comprising:
a bicycle having a part selected for use in locking it to a fixed structure;
a securing structure;
a locking device comprising:
a pair of elongated one piece self supporting shackles each having two ends;
a first cross bar and a second cross bar, each cross bar having a pair of spaced apart receptacles for one end of each shackle, the receptacles being proximate ends of the cross bars whereby when the shackles are installed in the receptacles they terminate inside the respective cross bar and the shackles will be in a spaced apart relationship and each of the cross bars having a locking mechanism co-operative with the ends of the shackles to allow the ends of the shackles when the shackles are in the receptacles to be locked and to be released from locking upon operation of the locking mechanism of the cross bar;
the locking device being locked and placed to capture the part of the bicycle and the fixed structure in a manner such that one of the cross bars is positioned upwardly relative to the other cross bar;
whereby the locking device can be opened by accessing the cross bar that is upwardly positioned.

13. A method for locking and unlocking a bicycle to a selected fixed structure comprising:
providing a locking device comprising:
a pair of elongated one piece self supporting shackles each having two ends;
a first cross bar and a second cross bar, each cross bar having a pair of spaced apart receptacles for receiving and locking therein one end of each shackle, the receptacles being proximate ends of the cross bars whereby when the shackles are installed in the receptacles they terminate inside the respective cross bar and the shackles will be in a spaced apart relationship and each of the cross bars having a locking mechanism co-operative with the ends of the shackles when in the receptacles to allow the ends of the shackles to be locked and to be released from locking upon operation of the locking mechanism of the cross bar;
having one of the locking mechanisms open so as to allow the locking device to be placed to capture a part of the bicycle and the selected fixed structure;
placing the locking device to capture the bicycle and the selected fixed structure; and
locking the locking device;
whereby the locking device can be installed by opening the locking mechanism at either cross bar and it can be removed by opening the locking mechanism at either cross bar.
